(19) United States
(12) Patent Application Publication
(10) Pub. No.: US 2021/0370973 A1
(43) Pub. Date: Dec. 2, 2021

(54) Driving Control Method by Cluster Group Formation of Autonomous Driving Vehicle

(71) Applicants: Hyundai Motor Company, Seoul (KR); Kia Motors Corporation, Seoul (KR)

(72) Inventor: Hamada Kazuyuki, Yokohama (JP)

(21) Appl. No.: 17/197,961

(22) Filed: Mar. 10, 2021

(30) Foreign Application Priority Data
May 28, 2020 (JP) 2020-93205

(51) Int. Cl. B60W 60/00; B60W 30/095; B60W 40/09; H04W 4/46

(52) U.S. Cl. CPC B60W 60/0017; B60W 30/095; H04W 4/46; B60W 40/09; B60W 60/0027

(57) ABSTRACT

A driving control method can be performed by a host vehicle. The method includes checking a target vehicle driving around the host vehicle, requesting information sharing from the target vehicle, inquiring about presence of an emergency risk avoidance driving rule and a type thereof when the information sharing with the target vehicle is allowed, and forming a cluster group for driving when the target vehicle sharing the information and the host vehicle have the same emergency risk avoidance driving rule.

### CROSS-REFERENCE TO RELATED APPLICATIONS

This application claims priority to Japan Patent Application No. 2020-93205, filed on May 28, 2020, which application is hereby incorporated herein by reference.

### TECHNICAL FIELD

Embodiments relate to a driving control method by cluster group formation of autonomous driving vehicles.

### BACKGROUND

Vehicles have been equipped with detection means such as various sensors and cameras, and a controller that controls the vehicle on the basis of the detection result of the detection means, and risk avoidance technology, such as automatically applying a brake or operating a steering wheel, have been put into practical use in response to a risk that may be caused by a driver's negligence or operation mistake. The risk avoidance technology has evolved as a support system for reducing driving load of a driver, and furthermore, development has progressed toward the practical use of autonomous driving technology in future.

Various technologies have already been proposed for autonomous driving technology. In the case of autonomous driving of the vehicle, on a path to a point input as a target, a host vehicle always inputs the situation around the host vehicle as data, and drives while adjusting the speed or selecting the lane according to the surrounding situation. When a target vehicle drives around the host vehicle, an accident may occur when the host vehicle does not drive by predicting the target vehicle's movement. Therefore, since the load on the controller increases when the target vehicle drives around the host vehicle, a technology for sharing information between vehicles through vehicle-to-vehicle communication has also been developed.

In Japan Patent Application Publication No. 2007-176355, an autonomous driving control device is disclosed. The autonomous driving control device includes a receiving means receiving information on surrounding vehicles, a calculating means calculating the driving speed of the host vehicle on the basis of information of the surrounding vehicle that is received by the receiving means, and a driving control means controlling driving of the host vehicle on the basis of the driving speed that is calculated by the calculating means.

Furthermore, a technology in which vehicles having the same purpose form a formation by using the vehicle-to-vehicle communication and drive in the formation while maintaining a safe positional relationship. By driving in the formation, it is possible to obtain an effect that the load on the controller is reduced because vehicles other than a leading vehicle may follow a preceding vehicle.

In Japan Patent Application Publication 2001-6099, a formation driving control device for a vehicle in the formation driving is disclosed. A vehicle driving independently from a vehicle group in formation driving has a means for requesting the incorporation of the formation to a leading vehicle of the vehicle group. The leading vehicle has a means for allowing or disallowing the incorporation of the independently driving vehicle, and when the leading vehicle allows the incorporation of the independently driving vehicle, the independently driving vehicle changes into autonomous driving in which the independently driving vehicle follows the leading vehicle of the vehicle group.

The above technologies are premised on control in performing normal driving. However, an unintended risk may occur in the actual driving. The normal driving control may not cope with all of a fallen object in front, a vehicle driving in reverse, etc. When an unavoidable emergency risk occurs, a driving rule reducing a risk of collision or contact is needed. However, since no world standard driving rule is currently set, driving rules for emergency are different for each vehicle manufacturer or vehicle type.

As described above, when an unavoidable emergency risk occurs in a situation in which vehicle having different emergency driving rules drive and each of the vehicles corresponds a respective emergency driving rule, the risk of a secondary accident is also likely to increase. Conversely, when the vehicles have the same emergency driving rule, it is possible to avoid the risk of a secondary accident in an unavoidable emergency risk. Thus, there is a need to provide a driving control method in consideration of the emergency driving rule.

### SUMMARY

Embodiments of the present disclosure relate to a driving control method by cluster group formation of an autonomous driving vehicle. In particular embodiments, when a target vehicle that drives around a host vehicle and the host vehicle have the same emergency risk avoidance driving rule for defining impact reduction driving control when an unavoidable emergency risk occurs, the driving control method is capable of reducing an emergency risk by a cluster group formed by the host vehicle and the target vehicle.

Embodiments can avoid problems in the driving control method of the conventional autonomous driving vehicle and provide a driving control method by cluster group formation of an autonomous driving vehicle. When a target vehicle that drives around a host vehicle and the host vehicle have the same emergency risk avoidance driving rule for defining impact reduction driving control when unavoidable emergency risk occurs, the driving control method is capable of reducing an emergency risk by a cluster group formed by the host vehicle and the target vehicle.

According to one aspect of the present disclosure, a driving control method is provided for reducing an emergency risk when a plurality of vehicles during autonomous driving drives within the same section. The driving control method includes checking, by a host vehicle, a target vehicle driving around the host vehicle; requesting, by the host vehicle, information sharing from the target vehicle checked; inquiring, by the host vehicle, when the information sharing with the target vehicle is allowed, the target vehicle about presence of an emergency risk avoidance driving rule and a type thereof; and forming, by the host vehicle and the target vehicle, when the target vehicle sharing the information and the host vehicle have the same emergency risk avoidance driving rule, a cluster group for driving, wherein the emergency risk avoidance driving rule may be a rule defining a vehicle control method performing impact reduction driving control when an unavoidable emergency risk occurs.

When a result of inquiring the presence and the type of the emergency risk avoidance driving rule by the host vehicle may represent that the target vehicle may have a different emergency risk avoidance driving rule from the host vehicle, the driving control method may further include: checking, by the host vehicle, positional relationship between the host vehicle and the target vehicle and determining whether or not the host vehicle is affected when an emergency risk occurs, and allowing the target vehicle to drive in the cluster group when it is determined that the host vehicle is not affected.

During normal driving, the target vehicle that may be allowed to drive in the cluster group may drive according to a normal-driving risk avoidance behavior rule based on at least one of safety checking means including a driving style, a specification, and a mounted sensor of a vehicle driving around the target vehicle, and when the emergency risk occurs, the target vehicle may drive according to the emergency risk avoidance driving rule.

The determining whether or not the host vehicle is affected when the emergency risk occurs may include: acquiring, by the host vehicle, the emergency risk avoidance driving rule controlling the target vehicle from the target vehicle; and calculating a risk potential from driving state data including speed and acceleration of each of the host vehicle and the target vehicle, and positional relationship between the host vehicle and the target vehicle to obtain a risk potential level, and determining whether or not the obtained risk potential level is less than or equal to a preset risk potential level, by the host vehicle.

The determining whether or not the host vehicle is affected when the emergency risk occurs may include: acquiring, by the host vehicle, the emergency risk avoidance driving rule controlling the target vehicle from the target vehicle; and obtaining a risk potential level based on positional relationship between the host vehicle and the target vehicle and the impact on driving control of the host vehicle by the driving control information of the target vehicle, which may be assumed when the target vehicle complies with the emergency risk avoidance driving rule of the target vehicle, and determining whether or not the obtained risk potential level may be less than or equal to a preset risk potential level, by the host vehicle.

Through the driving control method by the cluster group formation of the autonomous driving vehicle of the present disclosure, the vehicles having the same emergency risk avoidance driving rule drive by forming the cluster group. Accordingly, when an unavoidable emergency risk occurs, the vehicles in the cluster group perform risk avoidance control by the same control rule, so that it is possible to avoid or reduce a secondary accident accompanying the impact reduction driving control.

Furthermore, through the driving control method by the cluster group formation of the autonomous driving vehicle of the present disclosure, even when there is a vehicle that does not participate in the vehicle group in formation driving with the same purpose, the cluster group is formed according to the same emergency risk avoidance driving rule to enlarge the group of vehicles with similar driving control, so that it is possible to control the reduction of damage such as collision when an emergency risk occurs.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view schematically showing cluster group formation of an autonomous driving vehicle, in a driving control method by the cluster group formation of the autonomous driving vehicle according to an embodiment of the present disclosure;

FIGS. 2A, 2B, and 2C are views showing examples of an avoidance behavior that is assumed as an emergency risk avoidance driving rule according to the embodiment of the present disclosure;

FIGS. 3A and 3B are views showing information examples used for driving control in normal driving and driving control in emergency risk according to the embodiment of the present disclosure;

FIG. 4 is a view showing an information example of driving control of the emergency risk avoidance driving rule, which is shared with a target vehicle, according to the embodiment of the present disclosure;

FIG. 5 is a flowchart showing the driving control method by the cluster group formation of the host vehicle according to the embodiment of the present disclosure;

FIG. 6 is a flowchart showing a method for determining approval or disapproval of driving by the cluster group formation with respect to the target vehicle around the host vehicle according to the embodiment of the present disclosure;

FIG. 7 is a flowchart showing the method for determining approval or disapproval of driving by the cluster group formation with respect to the target vehicle around the host vehicle according to the embodiment of the present disclosure;

FIG. 8 is a view showing an example of setting a risk potential level according to the embodiment of the present disclosure, which is based on a position and the emergency risk avoidance driving rule of the target vehicle; and

FIG. 9 is a flowchart showing a method of setting the risk potential level according to the embodiment of the present disclosure, which is based on the emergency risk avoidance driving rule of the target vehicle.

### DETAILED DESCRIPTION OF ILLUSTRATIVE EMBODIMENTS

Hereinbelow, a preferred embodiment of the present disclosure for implementing a driving control method by cluster group formation of an autonomous driving vehicle will be described in detail with reference to the accompanying drawings.

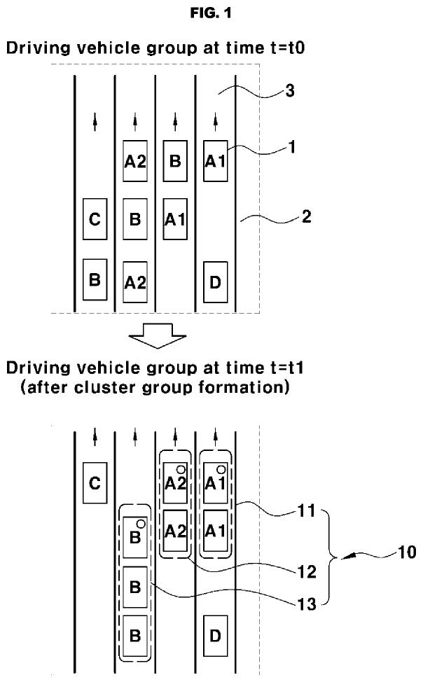

FIG. 1 is a view schematically showing cluster group formation of an autonomous driving vehicle, in the driving control method by the cluster group formation of the autonomous driving vehicle according to an embodiment of the present disclosure.

Referring to FIG. 1, in a drawing at the top of FIG. 1 showing a driving vehicle group of a timet=t0, nine vehicles A1, A2, B, C, and D run in the same direction on a road 2. The road 2 is an example of a four-lane road with four lanes 3. At least vehicles A1, A2, and B of the nine vehicles A1, A2, B, C, and D are autonomous driving vehicles that have communication means and are capable of communicating with other vehicles.

The autonomous driving vehicles input the surrounding situation of the host vehicle as data, and drive with speed adjustment and lane choice. In an autonomous driving vehicle in early stages of development, when a target vehicle drives around the host vehicle, while the host vehicle detects a position of the target vehicle by using a camera or a sensor provided therein to assume a driving speed or a heading direction of the target vehicle, the driving of the host vehicle should be controlled so that accidents such as collision with the target vehicle do not occur. In this case, there has been a problem that the calculation load of a controller is large.

However, with the development of vehicle-to-vehicle communication technology, it is possible for the host vehicle to acquire information of the target vehicle, and to control itself on the basis of the information, and the calculation load of the host vehicle for predicting the movement of the target vehicle is reduced. In particular, research has been also conducted on formation driving in which vehicles having a common request, such as a purpose or a destination, cooperate to form a line, and on the based on the information from a leading vehicle, a following vehicle of the vehicles in the line follows the leading vehicle while maintaining safety. Through the formation driving, it becomes possible for the following vehicle to significantly reduce the amount of calculation of the controller for driving control. In addition, even when an expected obstacle appears in front, the subsequent vehicle may notice the obstacle in advance by receiving information from the leading vehicle and avoid the obstacle or apply a brake, thereby preventing an accident.

When vehicles drive in a multiple-lane road, formation of the vehicles is not limited to a front and rear direction, and other vehicles also drive around the autonomous driving vehicle. Even when the host vehicle drives in the formation driving, a situation in which other vehicles without the formation driving drive in a lane adjacent to the autonomous driving vehicle frequently occurs. In the case of the multiple-lane road, it is necessary to perform driving control in consideration of accident avoidance between the host vehicle and other vehicles, in particular, including a lane adjacent to the autonomous driving vehicle.

As the driving control of the autonomous driving vehicle in consideration of accident avoidance between the host vehicle and the other vehicle, driving control in normal driving and driving control on two lanes when an unavoidable risk occurs is important. In the normal driving, even in a case of changing lanes, the driving control is performed within a range that does not affect a target vehicle, so accidents are difficult to occur. However, in a case of an unavoidable emergency risk, such as unexpected fallen objects and overturning of a leading vehicle due to a gust occurs, the host vehicle may not cope with all obstacles in the driving control during the normal driving. Therefore, an emergency risk avoidance driving rule different from the driving rule during the normal driving is required.

The emergency risk avoidance driving rule is a rule that establishes a vehicle control method that is provided to reduce the impact on the driving control when an unavoidable emergency risk occurs. When the host vehicle drives alone, in general, the host vehicle avoids an adjacent lane by rapidly controlling a steering wheel for avoiding any emergency risk. However, in a case in which the following vehicle drives in rear of the host vehicle, when the host vehicle performs the avoidance, a secondary accident may occur between the host vehicle and the following vehicle, and serious accidents may occur.

When the following vehicle has the same emergency risk avoidance driving rule as the host vehicle, and when a policy of emergency risk avoidance of the host vehicle may be instantaneously transmitted to the target vehicle, with the start of the emergency risk avoidance behavior of the host vehicle, the target vehicle may also apply a sudden brake to avoid the secondary accident.

The present disclosure provides a driving control method in which vehicles having the emergency risk avoidance driving rule form a cluster group with each other and efficiently cooperate and drive to reduce an emergency risk as a whole cluster group for the unavoidable sudden emergency risk. The method can be performed on board the host vehicle using processing circuitry, e.g., a processor and memory, to execute instruction steps described herein.

For example, in one embodiment, the host vehicle checks a target vehicle driving around the host vehicle. When the target vehicle presents around the host vehicle, the host vehicle shares information with the target vehicle, then inquires about presence of an emergency risk avoidance driving rule of the target vehicle and a type thereof. When the target vehicle has the same emergency risk avoidance driving rule as the host vehicle, the host vehicle forms a cluster group with the target vehicle.

The cluster group described herein is a group of vehicles that are possible to reduce an emergency risk as a whole for an unavoidable sudden emergency risk, and there is no need to limit normal driving conditions. Therefore, the target vehicle that is allowed to drive while forming the cluster group drives according to the emergency risk avoidance driving rule, at least in case of an emergency risk. However, in the normal driving, the target vehicle drives according to a risk avoidance behavior rule in the normal driving, which is based on at least one of safety confirmation means including a driving style, a specification, and a mounted sensor of a vehicle driving around the target vehicle.

When the host vehicle and the target vehicle have the same emergency risk avoidance driving rule, for example, driving control information used in the driving control may be expressed in a common format, and the driving control information transmitted to the target vehicle may be restrained into the minimum required amount of information, such as, may be limited into a preset parameter. In addition, when a behavior policy for an assumed emergency risk is coded in advance, in an emergency, the host vehicle may transmit the behavior policy thereof to the target vehicle by transmitting a code. As described above, as the host vehicle behavior policy of the minimum required amount of information is transmitted to the target vehicle, the time to transmit information may be shortened. In addition, the target vehicle receiving the host vehicle behavior policy may save energy in the calculation of the driving control according to the preset rule, and thus, the target vehicle may cope with risk in a short time.

As described above, the vehicles having the same emergency risk avoidance driving rule form the cluster group, and drive in the associated state, so that an emergency risk may be reduced.

Referring again to FIG. 1, the view shows that vehicles indicated as the same code have the same emergency risk avoidance driving rule. For example, two autonomous driving vehicles 1 indicated as A1 have the same emergency risk avoidance driving rule. Likewise, two autonomous driving vehicles 1 indicated as A2 and three autonomous driving vehicles 1 indicated as B have the respective same emergency risk avoidance driving rules.

In a driving vehicle group at a time t=t0, each vehicle drives while being scattered across a four-lane road. However, a host vehicle and a target vehicle around the host vehicle share information as described above, and when the host vehicle and the target vehicle that shares the information with the host vehicle have the same emergency risk avoidance driving rule, the host vehicle and the target vehicle form the cluster group.

In a lower view of the driving vehicle group at a time t=ti in FIG. 1, the view shows the driving vehicles after forming the cluster group 10 (hereinbelow, a reference numeral 10 is used in a case of collectively referring the cluster group). A cluster group 11 includes the two autonomous driving vehicles 1 indicated as A1, a cluster group 12 includes the two autonomous driving vehicles 1 indicated as A2, and a cluster group 13 includes the three autonomous driving vehicles 1 indicated as B. The vehicles included in each cluster group 11, 12, 13 have the same emergency risk avoidance driving rule, but vehicles in different cluster groups 10, for example, the vehicles of the cluster group 11 and the vehicles of the cluster group 12 have the respective emergency risk avoidance driving rules that are different for each group.

Isolated-driving vehicles indicated as C and D are vehicles without a common emergency risk avoidance driving rule to other vehicles. The isolated-driving vehicles C and D may be autonomous driving vehicles without an emergency risk avoidance driving rule, or may be a manual driving vehicle without a controller for autonomous driving.

In FIG. 1, the vehicles forming each of the cluster groups 11, 12, and 13 drive vertically side by side in the same lane 3, and a front vehicle with a round seal indicates a leading vehicle leading other vehicles in the same cluster group 10. There is no particular limitation on which any vehicle will be the leading vehicle among the vehicles of the same cluster group 10. However, since a leading vehicle requires more calculation processing for the driving control compared to following vehicles, for example, the cluster group 10 is formed such that a vehicle with a controller having a high calculation processing performance among the same cluster group 10 becomes the leading vehicle. Whereby, the leading vehicle may perform driving control calculation of a host vehicle including the same cluster group 10, and transmit information about motion vector and position during driving to the following vehicle, and the following vehicle may control the host vehicle on the basis of the information about motion vector and position transmitted from the leading vehicle.

Conversely, when there is substantially no difference in the calculation processing performance between the vehicles in the same cluster group 10, in order to reduce the load on the calculation processing of the leading vehicle, the following vehicles may be configured to shape a part of the calculation processing of the leading vehicle.

The cluster group 13 is an example of a cluster group including the three autonomous driving vehicles 1 shown as B. The three autonomous driving vehicles during independent driving may check that the three vehicles have the same emergency risk avoidance driving rule, and may form one cluster group 13. Furthermore, among the three vehicles, in a state in which two vehicles of the three vehicles drive in the formation driving, it may be confirmed that the remaining one vehicle that has been driving independently has the same emergency risk avoidance driving rule as the two vehicles, and the remaining vehicle may participate to the formation of the two vehicles to form one cluster group 13.

Since a target vehicle included in a different cluster group 10 from the host vehicle or an independent-driving target vehicle does not have the same emergency risk avoidance driving rule as the host vehicle, when an unavoidable sudden emergency risk occurs, the behavior policy of the host vehicle is not instantaneously transmitted to the target vehicles. Therefore, the driving control is performed to widen a distance between the host vehicle and the target vehicle. In the embodiment, when a vehicle group of a different cluster group 10 without the same emergency risk avoidance driving rule as the host vehicle that is a leading vehicle of one cluster group 10 or the target vehicle in independent-driving drives around the host vehicle, the host vehicle may share part of information about a size of the cluster group 10 or the driving control with a leading vehicle of the different cluster group 10 or an autonomous driving vehicle in the independent driving. The vehicle may drive while widening a distance between the vehicles through the shared information.

In FIG. 1, the vehicles included in each of the three cluster groups 11, 12, and 13 are shown as driving vertically side by side, but when the lane 3 may be multiple lines, the vehicles may drive in a horizontal or diagonal position relationship. In the above case, one of the vehicles forming the cluster group 10 may fulfill the role of the leading vehicle. Whereby, in general, when vehicles in the same cluster group 10 drive, and when a sudden obstacle appears in front of the target vehicle, it is also possible to adopt an avoidance method in which the host vehicle deviates to the front of the target vehicle, assuming that the target vehicle applies a sudden brake.

Furthermore, the example in which two or three vehicles participate to form the cluster group 10 is shown in FIG. 1, but more vehicles than the example may form the cluster group 10. In this case, the leading vehicle is not limited to one vehicle and may be multiple vehicles.

For example, in the example of FIG. 1, the vehicles shown as A1 and the vehicles shown as A2 form the different cluster groups 11 and 12, respectively, but in another embodiment, the vehicles shown as A1 and the vehicles shown as A2 have the same common emergency risk avoidance driving rule, and the four vehicles having code A, that is, the two vehicles of A1 and the two vehicle of A2, form the one cluster group 10. When many vehicles form the cluster group 10, even when each vehicle has the same emergency risk avoidance driving rule, it cannot be said that other rules and purposes of each vehicle are consistent. For example, each group of the two vehicles of A1 and the two vehicles of A2 has the common risk avoidance driving rule in the normal driving, but the risk avoidance driving rule in the normal driving of the two vehicles of A1 is different from the risk avoidance driving rule in the normal driving of the two vehicles of A2. In this case, within the one cluster group 10, the vehicles of A1 and the vehicles of A2, which have a high commonality in the rule, may drive together, and the leading vehicle may be preset for each group.

In addition, in the other embodiment, there is no distinction between A1 and A2, the four vehicles having code A form the one cluster group 10, and among the four vehicles, vehicles having a controller having a high calculation processing may be preset as the leading vehicle without limitation to one vehicle.

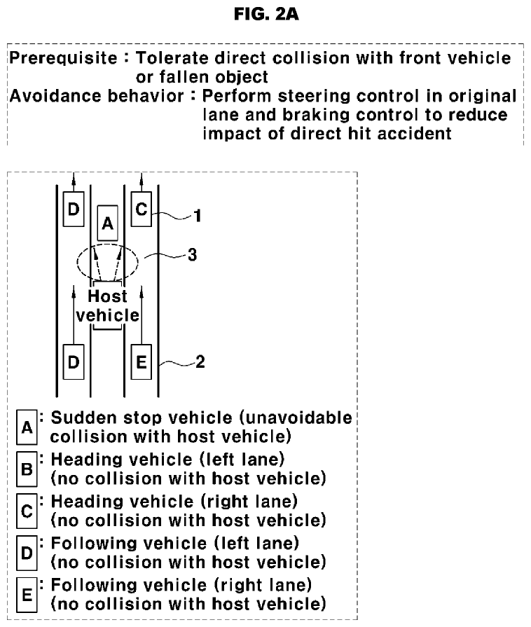

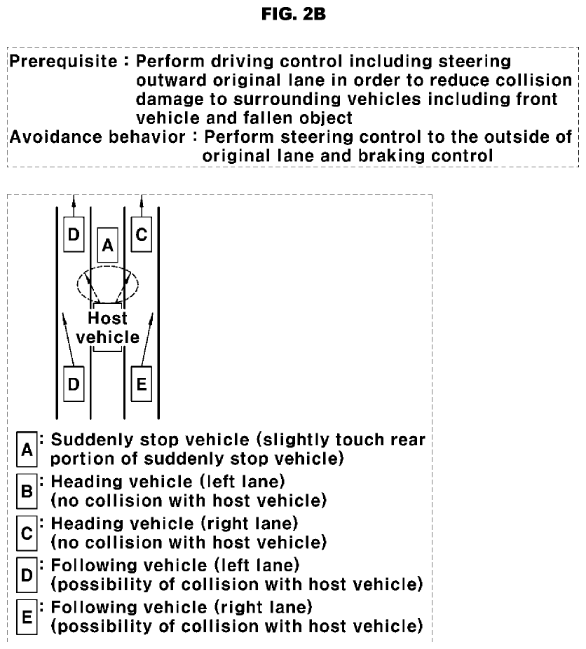

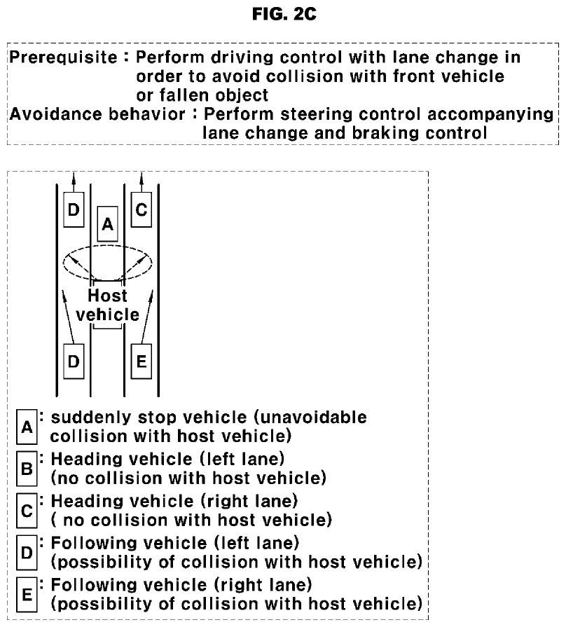

FIGS. 2A to 2C are views showing examples of an avoidance behavior assumed as the emergency risk avoidance driving rule according to the embodiment of the present disclosure.

Avoidance behavior of the host vehicle when an obstacle, such as an emergency stopping vehicle or a fallen object, presents in front of the host vehicle is shown into three cases in FIGS. 2A to 2C based on whether or not the host vehicle remains in the lane 3.

In FIG. 2A, a prerequisite is to tolerate collision with the obstacle, such as the emergency stopping vehicle or the fallen object in the front, and an avoidance behavior is to perform steering control and braking control in an original lane of a host vehicle, and to reduce impact of a direct hit accident.

Referring to FIG. 2A, the drawing shows a state in which the host vehicle and other vehicles shown as A to E drive in one side of a three-lane road 2, and a state in which a vehicle A driving in front of the host vehicle driving in a center lane 3 of the three-lane road 2 stops suddenly. In a left-side lane 3 of the host vehicle, a vehicle B dives ahead of the host vehicle and a vehicle D drives behind the host vehicle. Likewise, in a right-side lane C of the host vehicle, a vehicle C drives ahead of the host vehicle, and a vehicle E drives behind a vehicle E.

In the above case, for example, the vehicles D and E behind the host vehicle approach the host vehicle at high speed, or the vehicles D and E, and therefore, the vehicles D and E. Therefore, when the host vehicle deviates from the lane and avoids the danger, it is assumed that secondary accident due to a collision occurs between the vehicle D the vehicle E, thereby causing a greater accident.

Two dashed arrows are shown in the front of the host vehicle. The two arrows represent options to reduce any damage when the host vehicle inevitably collides with the suddenly stopped vehicle A. For example, when only one driver is in the host vehicle, it is highly likely that the driver is less injured when avoiding to the right even in the same lane. When it is highly likely that human damage is less by avoiding to the left due to a passenger in a passenger's seat or a stopped state of the vehicle A. Of course, when it is expected that the host vehicle going straight ahead without avoiding will reduce injury to the passenger, the host vehicle can also choose to go straight. As long as the host vehicle remains in the lane, collision between the host vehicle and the target vehicles B, C, D, and E does not occur.

In FIG. 2B, a prerequisite is to perform the driving control including steering to the outside of the original lane of the host vehicle in order to reduce collision damage to the surrounding vehicles including the front vehicle and the fallen object, and an avoidance behavior is to perform steering control and braking control to the outside of the original lane of the host vehicle.

In FIG. 2B, a positional relationship between the vehicles is the same as the positional relationship of FIG. 2A. However, in FIG. 2B the rear vehicles D and E drive at high speeds, and when the host vehicle shares the driving control information with the rear vehicles and performs the avoidance behavior of emergency risk, the rear vehicles D and E may also be expected to perform the avoidance behavior. Also in this case, whether the host vehicle deviates to which lane varies according to a situation of the rear vehicles D and E, in addition to a situation of passengers and a situation of the stopped vehicle A. For example, difference between the speed of the vehicle D and the speed of the vehicle E, or whether or not the vehicles D and E are large vehicles may be the basis of the determination.

In FIG. 2C, a prerequisite is to tolerate the driving control including lane change and collision with the rear vehicles in order to avoid collision with the front vehicle or the fallen object, and an avoidance behavior is to perform steering control to the outside of the original lane of the host vehicle and braking control.

In FIG. 2C, a positional relationship between the vehicles is the same as the positional relationship of FIG. 2A. However, in this case, even when the host vehicle collides with the rear vehicles, it is assumed that a risk is lower than when the host vehicle collides with the stopped vehicle A. In particular, when the host vehicle and the rear vehicles D and E have the same emergency risk avoidance driving rule, the avoidance behavior of the host vehicle may be transmitted to the rear vehicles D and E in a short time, and starts of the avoidance behaviors of the rear vehicles D and E is also accelerated, so that a risk of a secondary accident between the host vehicle and the rear vehicles may be reduced or avoided.

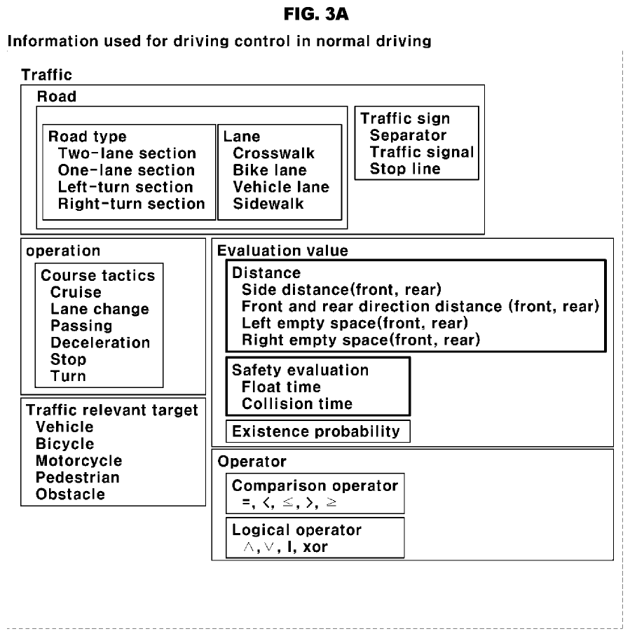

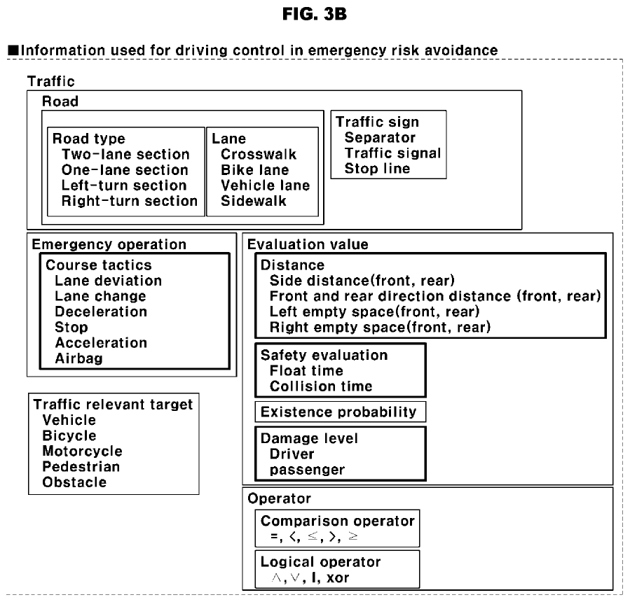

FIGS. 3A and 3B are views showing information examples used for the driving control in normal driving and the driving control in emergency risk according to the embodiment of the present disclosure, and FIG. 3A shows an example of information in normal driving and FIG. 3B shows an example of information in an emergency risk.

Referring to FIG. 3A, regarding traffic, a road type, a type of a lane related to the road type, traffic signs, etc. are referred to as the information used for the driving control in normal driving. In addition, regarding vehicle behavior, course tactics for progressing a course, such as lane change and deceleration, are referred to the information, and regarding traffic relevant target, a type of target, such as a vehicle or a pedestrian, is referred as the information. In addition, a distance to the target and the safety accompanying the time required for reaching the target are referred as evaluation values for information operation. In addition, operators for determined whether an assumed event occurs simultaneously at multiple places or occurs at either side are referred as the information.

Referring to FIG. 3B, the information about basic traffic and traffic relevant target is common with information used for the driving control in normal driving. However, as emergency operation, the information including the operation of an airbag on the premise of an emergency brake or a collision, or an assumed damage level to a driver or a passenger is different from the information of the driving control in normal driving. In addition, regarding the distance in the evaluation values, reference of distances between the host vehicle and front and rear vehicles when a collision is assumed is different from the driving control in normal driving.

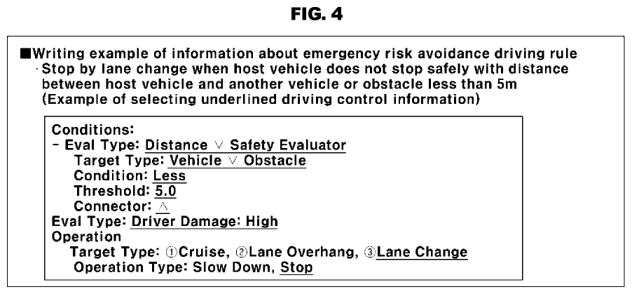

FIG. 4 is a view showing an information example of driving control of the emergency risk avoidance driving rule, which is shared with the target vehicle, according to the embodiment of the present disclosure. The driving control information shown in FIG. 4 is the example used for driving control in which the host vehicle stops by performing lane change when the host vehicle may not stop safely because a distance between the host vehicle and a target vehicle or an obstacle is less than 5 m.

In FIG. 4, underlined information is information selected to indicate the driving control. For example, only the underlined information may be transmitted to the target vehicle having the same emergency risk avoidance driving rule as the host vehicle by giving a pilcrow sign, and the target vehicle receiving the information may be configured to apply the information into a format in FIG. 4 to understand a trend of the host vehicle, i.e., a transmission source. Furthermore, the trend and the behavior policy of the host vehicle may be transmitted to the target vehicle by respectively coding an assumed event and a policy of operation at the event, designing a combined organized code, and transmitting the organized code.

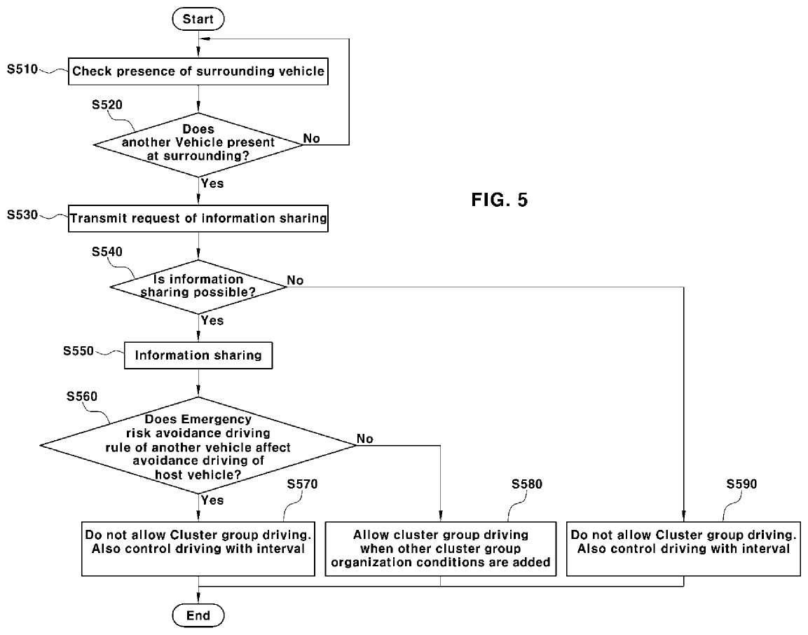

FIG. 5 is a flowchart showing the driving control method by the cluster group formation of the autonomous driving vehicle according to the embodiment of the present disclosure.

Referring to FIG. 5, the host vehicle checks the presence of the target vehicle driving around the host vehicle (S510). In the embodiment, the host vehicle checks the target vehicle by acquiring information, such as images or scattered light, using a camera or a sensor such as LiDAR (Light Detection and Ranging). Based on the information such as the acquired images and scattered light, a controller of the host vehicle performs image processing or analysis, and determines whether the target vehicle presents or not (S520). When the controller of the host vehicle determines that the target vehicle does not present, returning to S510, the presence of the target vehicle is repeatedly checked.

When the controller of the host vehicle determines that the target vehicle presents around the host vehicle (S520), the controller of the host vehicle requests the checked other vehicle to share information. The information sharing request is performed by transmitting a signal for requesting information sharing to the target vehicle by vehicle-to-vehicle communication using communication means provided in the host vehicle.

The target vehicle around the host vehicle is not limited to one vehicle. The situation of other vehicles around the host vehicle changes every moment, another new vehicle enters the surrounding of the host vehicle, and a target vehicle remains around the host vehicle at the same speed as the host vehicle for a while. In the embodiment, the controller of the host vehicle determines whether or not another new vehicle presents around the host vehicle (S520), and requests the newly-checked other vehicle to share information (S530).

Next, the controller of the host vehicle determines whether or not the target vehicle is capable of information sharing with the host vehicle by response from the target vehicle (S540). When the controller determines that the target vehicle is capable of information sharing with the host vehicle, the host vehicle shares the information with the target vehicle (S550).

The controller of the host vehicle inquires about presence of the emergency risk avoidance driving rule of the target vehicle and a type thereof to the target vehicle that has shared the information, and determines whether or not the emergency risk avoidance driving rule of the target vehicle affects the emergency risk avoidance driving control of the host vehicle (S560).

Determination described above is provided to determine whether or not the host vehicle forms the cluster group 10 together with the target vehicle. In the embodiment, when the target vehicle has the same emergency risk avoidance driving rule as the emergency risk avoidance driving rule of the host vehicle, the controller of the host vehicle determines that the emergency risk avoidance driving rule of the target vehicle does not affect the emergency risk avoidance driving control of the host vehicle. When the target vehicle has the emergency risk avoidance driving rule different from the emergency risk avoidance driving rule of the host vehicle, the controller of the host vehicle determines that the emergency risk avoidance driving rule of the target vehicle affects the emergency risk avoidance driving control of the host vehicle.

Hereinafter, it is described that the host vehicle and the target vehicle form the cluster group 10, when the emergency risk avoidance driving rule of the target vehicle is the same as the emergency risk avoidance driving rule of the host vehicle. However, even when the emergency risk avoidance driving rule of the target vehicle is different from the emergency risk avoidance driving rule of the host vehicle, there may be a case in which the emergency risk avoidance driving rule of the target vehicle does not affect the emergency risk avoidance driving control of the host vehicle depending on a driving situation, such as positional relationship and driving speeds of the two vehicles. In this case, the cluster group 10 may be formed. Accordingly, in another embodiment, the host vehicle determines whether or not the emergency risk avoidance driving rule of the target vehicle affects the emergency risk avoidance driving control of the host vehicle by adding a driving situation when the emergency risk avoidance driving rules of the two vehicles are not the same as each other, in addition to the correspondence of the emergency risk avoidance driving rules of the target vehicle and the host vehicle.

When the emergency risk avoidance driving control of the host vehicle is determined to be affected, driving in the cluster group is not allowed to the target vehicle (S570). Whereby, the host vehicle is controlled to drive while being spaced apart from the target vehicle rather than when the host vehicle and the target vehicle drive in the cluster group 10, and controlled to drive while being spaced apart from the target vehicle.

Conversely, when it is determined that the emergency risk avoidance driving rule of the target vehicle does not affect the emergency risk avoidance driving control of the host vehicle, the target vehicle is allowed to drive in the cluster group (S580). In S580, as a condition of the formation of the cluster group 10, a condition may be added to influence of the emergency risk avoidance driving control of the host vehicle. For example, conformity of the driving rule in normal driving may be added.

Returning to S540, when the target vehicle is unable to share the information with the host vehicle, the host vehicle does not allow the cluster group driving of the target vehicle. Accordingly, the host vehicle is controlled to drive while being spaced apart from the target vehicle rather than driving in the cluster group 10 with the target vehicle (S590).

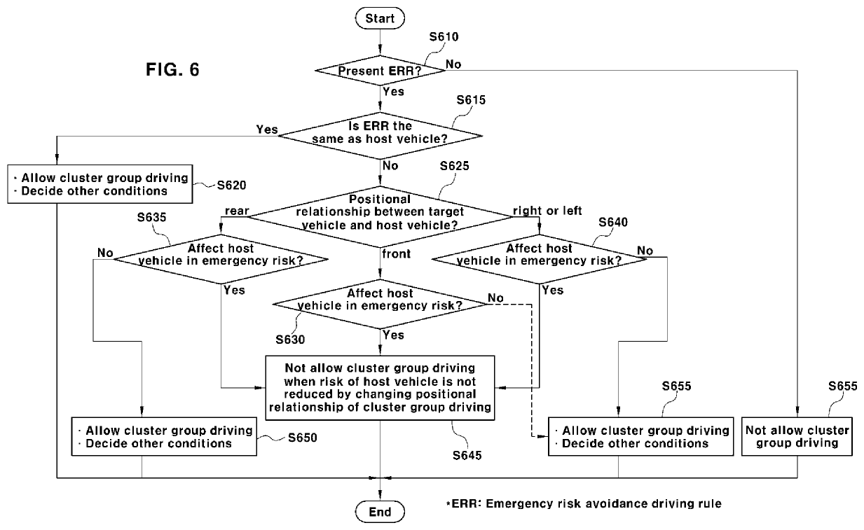

FIG. 6 is a flowchart showing a method for determining approval or disapproval of driving by the cluster group formation with respect to the target vehicle around the autonomous driving vehicle according to the embodiment of the present disclosure. FIG. 6 describes the determination of S560 in FIG. 5 in more detail. Referring to FIG. 6, in S610, the host vehicle inquires if the target vehicle has the emergency risk avoidance driving rule (indicated as ‘ERR’ in the drawing), and from the result, the host vehicle determines whether or not the target vehicle has the emergency risk avoidance driving rule (indicated as ‘ERR’ in the drawing). When the target vehicle does not have the emergency risk avoidance driving rule, the cluster group driving of the target vehicle is not allowed (S660).

When the target vehicle has the emergency risk avoidance driving rule, in S615, the host vehicle inquires a type of the emergency risk avoidance driving rule of the target vehicle, and from the result, the host vehicle determines whether or not the emergency risk avoidance driving rule of the target vehicle is the same as the emergency risk avoidance driving rule of the host vehicle. When the host vehicle determines that the emergency risk avoidance driving rule of the target vehicle is the same as the emergency risk avoidance driving rule of the host vehicle, the host vehicle allows the cluster group driving of the target vehicle, in S620. At this time, conformity of the driving rule in normal driving may be added to the conditions allowing the cluster group driving.

The host vehicle determines that the emergency risk avoidance driving rule of the target vehicle is different from the emergency risk avoidance driving rule of the host vehicle in S615. In this case, even when the rules are different, in an event of an emergency risk, the target vehicle may be allowed to drive in the cluster group, when the target vehicle may be determined not to affect the host vehicle by controlling driving according to the emergency risk avoidance driving rule of the target vehicle.

In the embodiment, in order to more accurately determine the impact on the host vehicle, positional relationship between the target vehicle and the host vehicle is determined in S625. For example, determination of the positional relationship between the target vehicle and the host vehicle may be performed by changing positional information generated by the global navigation satellite system (GNSS) of the two vehicles in the step of information sharing, and by using a camera and a sensor such as LiDAR provided in the host vehicle.

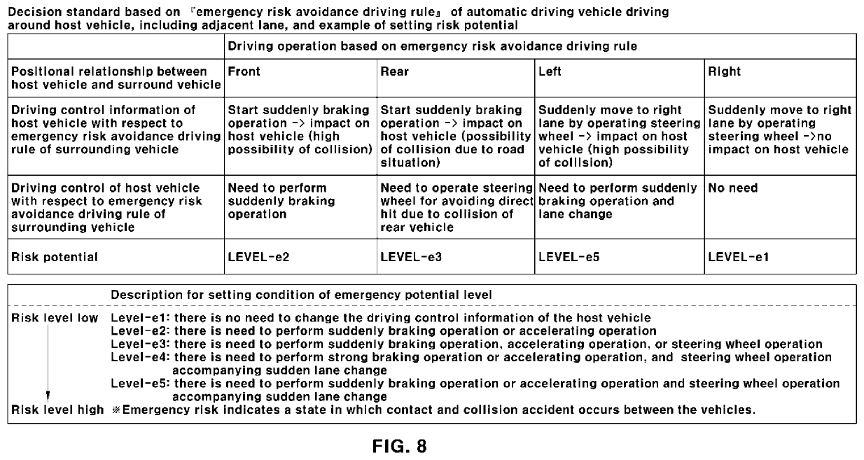

In response to the result of determination in S625, when the target vehicle drives in front of the host vehicle, the target vehicle is determined to affect the host vehicle in the emergency risk, in S630. When the target vehicle drives in rear of the host vehicle, the target vehicle is determined to affect the host vehicle in the emergency risk, in S635. When the target vehicle drives in the right side or the left side of the host vehicle, the target vehicle is determined to affect the host vehicle in the emergency risk, in S640. As described above, determination at each step on the basis of the positional relationship between the target vehicle and the host vehicle is because a risk of a secondary accident assumed the positional relationship between the target vehicle and the host vehicle varies. This point will be described later with reference to FIG. 8.

When determination processing is distributed according to the positional relationship between the target vehicle and the host vehicle, and when it is determined that the target vehicle does not affect the host vehicle, in any one of S630, S635, and S640, the host vehicle allows the cluster group driving of the target vehicle, in S650 or S655. As in S620, other conditions may be added to the condition allowing the cluster group driving. Conversely, when the target vehicle affect the host vehicle, in any one of S630, S635, and S640, the host vehicle does not allow the cluster group driving of the target vehicle, in S645. Additionally, the impact of the host vehicle when a driving position of the target vehicle in the cluster group driving is changed is examined, and when the host vehicle is affected even with adding the limitation, the cluster group driving of the target vehicle may not be allowed.

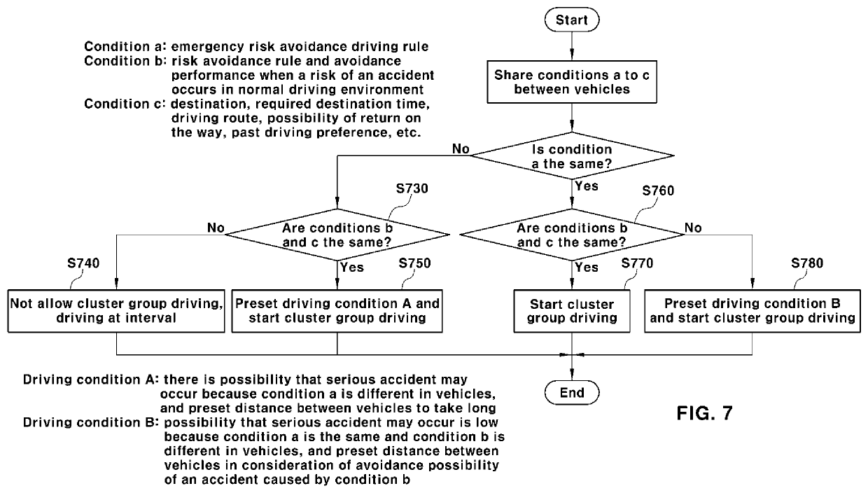

FIG. 7 is a flowchart showing the method for determining approval or disapproval of driving by the cluster group formation with respect to the target vehicle around the host vehicle according to the embodiment of the present disclosure. FIG. 7 describes S580 in FIG. 5, and S650 and S655 in FIG. 6 in more detail.

Referring to FIG. 7, as conditions of forming the cluster group 10, following three conditions a to c are preset:

Condition a: emergency risk avoidance driving rule, Condition b: risk avoidance rule and avoidance performance when a risk of an accident occurs in normal driving environment, and

Condition c: destination, required destination time, driving route, possibility of return on the way, past driving preference, etc.

In S710, the host vehicle and the target vehicle share the above three conditions a to c with each other. The condition sharing may be performed during the information sharing in S550 in FIG. 5.

For the decision of the conditions, the condition a is a priority. It is determined that whether or not the target vehicle and the host vehicle are the same in the priority condition a (S720).

When the target vehicle and the host vehicle are different from each other in the condition a, it is determined whether or not the target vehicle and the host vehicle are the same as each other in the conditions b and c, in S730. As a result, when and the target vehicle are different from the host vehicle in the conditions a to c, the host vehicle does not allow the cluster group driving of the evaluated target vehicle, in S740, and drives while being spaced apart from the target vehicle.

Meanwhile, in S730, when it is determined that the target vehicle and the host vehicle are the same in the conditions b and c, since a driving condition A as an additional condition, that is, the condition a is different in the vehicles, there is a possibility that a serious accident may occur when an emergency risk occurs. Accordingly, under a condition that a distance between the vehicles is preset to take long, the host vehicle allows the cluster group driving of the target vehicle (S750).

Returning to S720, when the target vehicle and the host vehicle are the same in the condition a, the host vehicle determines whether or not the target vehicle and the host vehicle are the same in the conditions b and c, in S760.

When the conditions b and c are the same in the host vehicle and the target vehicle in addition to the condition a, the host vehicle allows the cluster group driving of the target vehicle and starts the cluster group driving, in S770.

In S760, the host vehicle and the target vehicle are different from each other in the conditions b and c is a driving condition B as an additional condition, that is, the condition a is the same in the vehicles and the condition b is different in the vehicle. In this case, a possibility that a serious accident may occur when an emergency risk occurs is low, and under a condition that a distance between the vehicles are preset in consideration of the avoidance performance of an accident caused by the condition b, the host vehicle allows the cluster group driving of the target vehicle (S780).

FIG. 8 is a view showing an example of setting a risk potential level according to the embodiment of the present disclosure, which is based on a position and the emergency risk avoidance driving rule of the target vehicle.

As described above with reference to FIG. 6, since a risk of an assumed secondary accident varies due to the positional relationship between the target vehicle and the host vehicle, there is need to determine the position of the target vehicle in order to determine the impact on the host vehicle when an emergency risk occurs. In order to more accurately determine the impact on the host vehicle according to the positional relationship between the target vehicle and the host vehicle, a risk potential level is set in the embodiment and the risk potential is used as a decision standard.

FIG. 8 is the view showing the example of setting the risk potential level.

Referring to FIG. 8, for each positional relationship between the host vehicle and the target vehicle, the driving control information based on the emergency risk avoidance driving rule a surrounding vehicle, the driving control of the host vehicle with respect to the emergency risk avoidance driving rule of the surrounding vehicle, and the risk potential level therefor are shown in a tabular form.

Below the above driving operation, a description of conditions for setting the risk potential level is shown, and the level is preset into five levels E1 to E5 as follows.

Level-E1: there is no need to change the driving control information of the host vehicle.

Level-E2: there is need to perform sudden braking operation or accelerating operation.

Level-E3: there is need to perform sudden braking operation, accelerating operation, or steering wheel operation.

Level-E4: there is need to perform strong braking operation or accelerating operation, and steering wheel operation accompanying sudden lane change.

Level-E5: there is need to perform sudden braking operation or accelerating operation and steering wheel operation accompanying sudden lane change.

As an example, in a case in which the target vehicle is positioned in front of the host vehicle, as the driving control information based on the emergency risk avoidance driving rule of the surrounding vehicle, when the target vehicle performs sudden braking operation, a possibility of the collision of the host vehicle is greater, so the impact on the host vehicle is assumed. Therefore, sudden braking operation is required as the driving control of the host vehicle with respect to the emergency risk avoidance driving rule of the surrounding vehicle. The operation corresponds to the level-E2 from the description of the condition of the risk potential level.

In a case in which the target vehicle is positioned in the left side of the host vehicle, when the target vehicle moves sharply in a right lane by operating steering wheel to avoid an obstacle, since the host vehicle has a high possibility of collision, it is assumed that the host vehicle may be affected. In this case, since the target vehicle may squeeze in front of the host vehicle, sudden braking operation and lane change are required. The above operation corresponds to the level-E5.

In the embodiment of the present disclosure, when determination in which the host vehicle is affected is performed in an emergency risk, the host vehicle acquires the emergency risk avoidance driving rule controlling the target vehicle from the target vehicle, and obtains the risk potential level on the basis of the positional relationship between the host vehicle and the target vehicle and the impact on the driving control of the host vehicle by the driving control information of the target vehicle that is assumed when the target vehicle complies with the emergency risk avoidance driving rule of the target vehicle. As a result, it is determined whether or not the required risk potential level is less than or equal to a preset level, and when the risk potential level is less than or equal to the preset level, the host vehicle allows the target vehicle to form the cluster group 10.

In FIG. 8, for example, in a case in which the level-E2 or less is preset as the decision standard for allowing the cluster group driving, the driving control method may be configured as follow. When the target vehicle is positioned in the front or the right side of the host vehicle, the cluster group driving is allowed, and when the target vehicle is positioned in the rear or the left side of the host vehicle, the cluster group driving is not allowed.

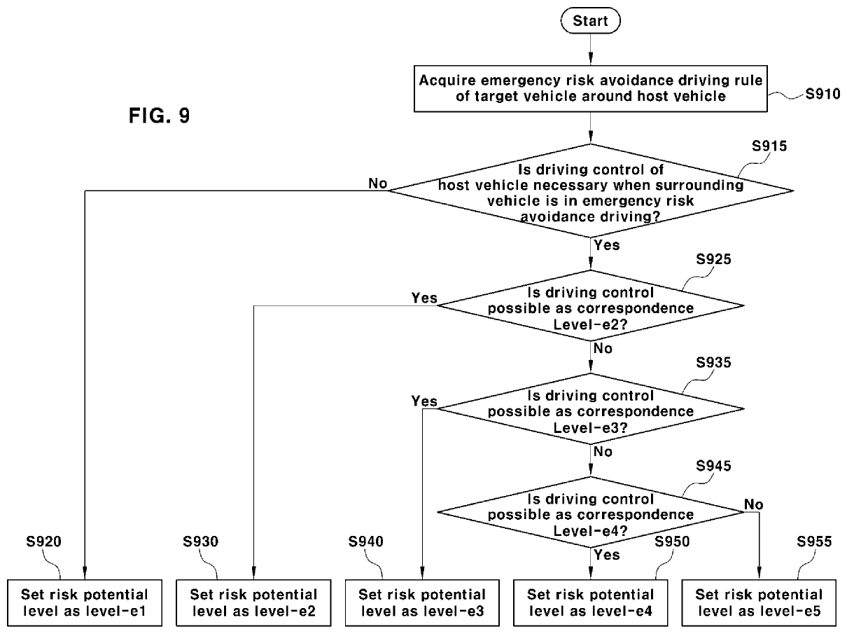

FIG. 9 is a flowchart showing a method of setting the risk potential level according to the embodiment of the present disclosure, which is based on the emergency risk avoidance driving rule of the target vehicle.

Referring to FIG. 9, the host vehicle acquires the emergency risk avoidance driving rule of the target vehicle around the host vehicle (S910). The host vehicle determines that the target vehicle needs the driving control of the host vehicle in the emergency risk avoidance driving (S915). When the target vehicle does not need the driving control of the host vehicle, the risk potential level is set as the level-E1 (S920). When the target vehicle needs the driving control of the host vehicle, the host vehicle determines whether the driving control for the target vehicle is possible as sequential correspondence from the level-E2 to the level-E4 (S925, 935, and 945), and sets the risk potential level according to the result (S930, 940, 950, and 955).

Setting the risk potential level is not limited to the above method. When it is determined whether or not the host vehicle is affected in an emergency risk, the host vehicle may acquire the emergency risk avoidance driving rule controlling the target vehicle from the target vehicle, calculate the risk potential from driving state data including speed, acceleration of each of the host vehicle and the target vehicle and the positional relationship between the host vehicle and the target vehicle, obtain the risk potential level, and determine whether the risk potential level is less than or equal to the preset level.

For example, when on a one-lane road extending in a x-axis direction, the host vehicle drives with speed v1 and acceleration a1 at a position x1 and the target vehicle drives with speed v2 and acceleration a2 at a position x2 in front of the host vehicle, the risk potential may be obtained as follows, for example.

When the distance between the host vehicle and the target vehicle is d, relative speed is vr, and relative acceleration is ar,

d=x2−x1

vr=v2−v1

ar=a2−a1

When float time to the preceding target vehicle, that is, a value indicating whether the distance becomes zero and whether the host vehicle and the target vehicle are brought into contact with each other after a few seconds when the present driving situation continues and v1, v2, and vr are constant, is TC, and TC is expressed as follows:

TC=−d/r (1)

Furthermore, in a case of the time between the vehicles, that is, in a case in which the host vehicle drives along the target vehicle, when a value indicating the impact on the float time TC due to an assumed change in vehicle speed of the target vehicle in the future is TW, TW is expressed as follows:

TW−d/1 (2)

By using the float time TC and the time between the vehicles TW, a normal term risk potential RPs and an excessive term risk potential RPt are, respectively

RPs=1/TW, and

RPt=1/TC,

The risk potential RP may be expressed as follows:

RP=(a/k)RPs+(1−(a/k))RPt (3)

Herein, integer k determines the absolute importance of RPs and RPt, and is a number that may be properly set in advance from results of tests.

In addition, a variable a determines the driving scenes in a normal state and an excessive state dynamically according to the driving state of the host vehicle and the target vehicle.

The risk potential when the vehicles are positioned in a plurality of lanes may be calculated by extending the calculation to two dimensions.

Accordingly, as the risk potential level is obtained by dividing the value of the risk potential step by step, and the risk potential level is compared with the preset level, it is possible to determine whether or not the host vehicle is affected when an emergency risk occurs.

Although the preferred embodiment of the present disclosure is described in detail with reference to the drawings, the present disclosure is not limited thereto, and those skilled in the art will appreciate that various modifications, additions, and substitutions are possible, without departing from the scope and spirit of the present disclosure.

What is claimed is:

1. A driving control method comprising:
checking, by a host vehicle, a target vehicle driving around the host vehicle;
requesting, by the host vehicle, information sharing from the target vehicle;
inquiring, by the host vehicle from the target vehicle, about presence of an emergency risk avoidance driving rule and a type thereof when the information sharing with the target vehicle is allowed, wherein the emergency risk avoidance driving rule is a rule defining a vehicle control method performing impact reduction driving control when an unavoidable emergency risk occurs; and
forming a cluster group for driving when the target vehicle sharing the information and the host vehicle have the same emergency risk avoidance driving rule.

2. The driving control method of claim 1, wherein, when a result of inquiring the presence and the type of the emergency risk avoidance driving rule by the host vehicle represents that the target vehicle has a different emergency risk avoidance driving rule from the host vehicle, the driving control method further comprises:
checking, by the host vehicle, a positional relationship between the host vehicle and the target vehicle;
determining whether or not the host vehicle is affected when an emergency risk occurs;
allowing the target vehicle to drive in the cluster group when it is determined that the host vehicle is not affected; and
not allowing the target vehicle to drive in the cluster group when it is determined that the host vehicle is affected.

3. The driving control method of claim 2, wherein during normal driving, the target vehicle is allowed to drive in the cluster group drives according to a normal-driving risk avoidance behavior rule based on at least one of safety check.

4. The driving control method of claim 3, wherein the at least one safety check includes a driving style, a specification, and a mounted sensor of a vehicle driving around the target vehicle.

5. The driving control method of claim 3, wherein when the emergency risk occurs, the target vehicle drives according to the emergency risk avoidance driving rule.

6. The driving control method of claim 5, wherein the at least one safety check includes a driving style, a specification, and a mounted sensor of a vehicle driving around the target vehicle.

7. The driving control method of claim 6, wherein determining whether or not the host vehicle is affected when the emergency risk occurs comprises:
acquiring, by the host vehicle from the target vehicle, the emergency risk avoidance driving rule controlling the target vehicle;
calculating a risk potential from driving state data that includes speed and acceleration of each of the host vehicle and the target vehicle, and the positional relationship between the host vehicle and the target vehicle to obtain a risk potential level; and
determining whether or not the obtained risk potential level is less than or equal to a preset risk potential level.

8. The driving control method of claim 6, wherein determining whether or not the host vehicle is affected when the emergency risk occurs comprises:
acquiring, by the host vehicle from the target vehicle, the emergency risk avoidance driving rule controlling the target vehicle;
obtaining a risk potential level based on the positional relationship between the host vehicle and the target vehicle and the impact on driving control of the host vehicle by driving control information of the target vehicle; and
determining whether or not the obtained risk potential level is less than or equal to a preset risk potential level.

9. The driving control method of claim 8, wherein the impact on driving control of the host vehicle by the driving control information of the target vehicle is assumed when the target vehicle complies with the emergency risk avoidance driving rule of the target vehicle.

10. The driving control method of claim 5, wherein determining whether or not the host vehicle is affected when the emergency risk occurs comprises:
acquiring, by the host vehicle from the target vehicle, the emergency risk avoidance driving rule controlling the target vehicle;
calculating a risk potential from driving state data that includes speed and acceleration of each of the host vehicle and the target vehicle, and the positional relationship between the host vehicle and the target vehicle to obtain a risk potential level; and
determining whether or not the obtained risk potential level is less than or equal to a preset risk potential level.

11. The driving control method of claim 5, wherein determining whether or not the host vehicle is affected when the emergency risk occurs comprises:
acquiring, by the host vehicle from the target vehicle, the emergency risk avoidance driving rule controlling the target vehicle;
obtaining a risk potential level based on the positional relationship between the host vehicle and the target vehicle and the impact on driving control of the host vehicle by driving control information of the target vehicle; and
determining whether or not the obtained risk potential level is less than or equal to a preset risk potential level.

12. The driving control method of claim 11, wherein the impact on driving control of the host vehicle by the driving control information of the target vehicle is assumed when the target vehicle complies with the emergency risk avoidance driving rule of the target vehicle.

13. A vehicle comprising:
a plurality of sensors;
processing circuitry coupled to the sensors; and
a non-transitory memory coupled to the processing circuitry and storing instructions that, when executed by the processing circuitry, cause the vehicle to:
check a target vehicle driving around the vehicle;
request information sharing from the target vehicle;
when the information sharing with the target vehicle is allowed, inquire about presence of an emergency risk avoidance driving rule and a type thereof, wherein the emergency risk avoidance driving rule is a rule defining a vehicle control method performing impact reduction driving control when an unavoidable emergency risk occurs; and
form a cluster group for driving when the target vehicle sharing the information and the vehicle have the same emergency risk avoidance driving rule.

14. The vehicle of claim 13, wherein, when a result of inquiring the presence and the type of the emergency risk avoidance driving rule represents that the target vehicle has a different emergency risk avoidance driving rule from the vehicle, the instructions cause the vehicle to:
check, a positional relationship between the vehicle and the target vehicle;
determine whether or not the vehicle is affected when an emergency risk occurs;
allow the target vehicle to drive in the cluster group when it is determined that the vehicle is not affected; and
not allow the target vehicle to drive in the cluster group when it is determined that the vehicle is affected.

15. The vehicle of claim 14, wherein during normal driving, the target vehicle is allowed to drive in the cluster group drives according to a normal-driving risk avoidance behavior rule based on at least one safety check.

16. The vehicle of claim 15, wherein the target vehicle is caused to drive according to the emergency risk avoidance driving rule when the emergency risk occurs.

17. The vehicle of claim 16, wherein the at least one safety check includes a driving style, a specification, and a mounted sensor of a vehicle driving around the target vehicle.

18. The vehicle of claim 17, wherein it is determined whether or not the vehicle is affected when the emergency risk occurs by:
acquiring, from the target vehicle, the emergency risk avoidance driving rule controlling the target vehicle;
calculating a risk potential from driving state data that includes speed and acceleration of each of the vehicle and the target vehicle, and the positional relationship between the vehicle and the target vehicle to obtain a risk potential level; and
determining whether or not the obtained risk potential level is less than or equal to a preset risk potential level.

19. The vehicle of claim 16, wherein it is determined whether or not the vehicle is affected when the emergency risk occurs by:
acquiring, from the target vehicle, the emergency risk avoidance driving rule controlling the target vehicle;
obtaining a risk potential level based on the positional relationship between the vehicle and the target vehicle and the impact on driving control of the vehicle by driving control information of the target vehicle; and
determining whether or not the obtained risk potential level is less than or equal to a preset risk potential level.

20. The vehicle of claim 19, wherein the impact on driving control of the vehicle by the driving control information of the target vehicle is assumed when the target vehicle complies with the emergency risk avoidance driving rule of the target vehicle.
